(19) United States
(12) Patent Application Publication
(10) Pub. No.: US 2024/0185657 A1
(43) Pub. Date: Jun. 6, 2024

(54) Securely Controlling an Electronic Lock

(71) Applicant: ERA Home Security Limited, West Midlands (GB)

(72) Inventors: Jeyarajasingam Jeyasingam, West Midlands (GB); Babatunde Gary Awoyemi, West Midlands (GB)

(21) Appl. No.: 18/553,306

(22) PCT Filed: Mar. 30, 2022
(86) PCT No.: PCT/GB2022/050799

§ 371 Date: Sep. 29, 2023

(30) Foreign Application Priority Data
Apr. 1, 2021 (GB) 2104757.6
Nov. 15, 2021 (GB) 2116404.1

(51) Int. Cl. G07C 9/00; G07C 9/25; G07C 9/27

(52) U.S. Cl. CPC G07C 9/00563; G07C 9/00309; G07C 9/00571; G07C 9/25; G07C 9/27; G07C 2009/00412

(57) ABSTRACT

A method of controlling an electronic lock comprises establishing (402) a short-range wireless communication link (104) between an electronic lock (200) and a mobile device (102), and establishing (404) a wide-area network communication link (106) between a server (300) and a mobile device (102). A communication session between the server (300) and the electronic lock (200) is established (406), which enables exchanging data between the electronic lock and the server over a communication path comprising the short-range wireless communication link and a wide-area network communication link. The server subsequently sends a command (408) to the electronic lock using the communication session, wherein the command causes the electronic lock to lock or unlock (412) a locking mechanism of the electronic lock.

The present disclosure relates to an electronic lock. More specifically, but without limitation, the present disclosure describes techniques for improving the cyber security of an electronic lock.

A “smart lock” is a type of electronic lock that provides advanced functionality not found on traditional mechanical or electronic locks. For example, smart locks may have the ability to be remotely unlocked, that is, to be unlocked by a user who is not near the lock. As another example, smart locks may have the ability to be unlocked using a smartphone application, thus avoiding the need for a user to carry a physical key.

However, the functionality of smart locks creates security vulnerabilities that are not present in traditional locks. For example, remote unlocking requires the smart lock to be connected to the Internet, which provides an opportunity for a cyber-attacker to unlock the lock. Providing the ability to unlock using a smartphone application can allow a cyber-attacker to unlock the lock by compromising the application or by installing a nefarious application on the smartphone.

### SUMMARY

The present disclosure provides methods, apparatuses and a system for securely controlling an electronic lock.

According to a first aspect of the disclosure, there is provided a method of controlling an electronic lock. The method is performed at the electronic lock, and may comprise establishing a short-range wireless communication link between the electronic lock and a mobile device. The method may further comprise establishing a communication session with a server, wherein the communication session enables exchanging data between the electronic lock and the server over a communication path comprising the short-range wireless communication link and a wide-area network communication link between the mobile device and the server. The method may further comprise receiving a command from the server using the communication session. The method may further comprise, in response to receiving the command, locking or unlocking the electronic lock.

Locking and/or unlocking the electronic lock is controlled by a server, which is located remotely from the electronic lock. The communication path between the electronic lock and the server includes a short-range wireless communication link, which is implemented by a mobile device. Since the mobile device is portable, the short-range wireless link exists only when the mobile device is within range of the electronic lock and, therefore, the electronic lock is not permanently connected to the wide-area network. This reduces the risk of an attacker compromising the lock by connecting to it via the wide-area network.

The mobile device acts as a conduit to allow the electronic lock to establish a communication session with a trusted remote server, but is not able to control locking or unlocking of the electronic lock without the server. This system prevents a compromised mobile device being used to lock or unlock the electronic lock.

The term “mobile device” is intended only to facilitate identification, and should not be taken to imply any limitations or requirements on the form or capabilities of the hardware used to implement the mobile device. The mobile device may be any suitable type of computing device, such as a smartphone, tablet computer, laptop computer, gaming device, vehicle computer system (e.g., a vehicle infotainment system) or a wearable device (e.g., a smartwatch). In general, the mobile device is portable, i.e., it can be moved relative to the electronic lock. In particular, the mobile device is intended to be moved into, and out of, range of the short-range communication link with respect to the lock. The mobile device can be carried by a user to facilitate locking and/or unlocking the electronic lock.

The term “server” is intended only to facilitate identification, and should not be taken to imply any limitations or requirements on the form or capabilities of the hardware used to implement the server. For example, the server may take the form of a plurality of servers, which may or may not be distributed across multiple geographic locations, configured to act as a cloud service. However, the server is not a mobile device and, generally, the server is located remotely from the electronic lock (e.g., at a different geographic location, such that a wide-area network is needed for communication between the electronic lock and the server). The server will typically be configured to serve multiple electronic locks in the manner disclosed herein.

The short-range communication link may be implemented using a radio frequency wireless communication link. Non-limiting examples of technologies that may be used to implement a short-range radio frequency wireless communication link include Bluetooth™, Bluetooth™ Low Energy (BLE), ultra-wideband (UWB), near-field communication (NFC) and/or Zigbee™. Additionally or alternatively, the short-range communication link may be implemented using an optical (e.g., infrared (IR)), ultrasonic or audible communication link.

The short-range wireless communication link may comprise a communication link having a communication range of a few centimetres up to 200 metres. For example, the short-range wireless communication link may comprise Bluetooth™, Bluetooth™ Low Energy (BLE) and/or Zigbee™, which have an average communication range of approximately 10 metres and a maximum communication range of 100 metres. Alternatively, the short-range wireless communication link may comprise UWB, which has an average communication range of approximately 50 metres and a maximum communication range of 200 metres. In another implementation, the short-range wireless communication link may comprise NFC, which has a maximum communication range of 4 centimetres. In yet another implementation, the short-range wireless communication link may comprise an IR communication link, which has an average communication range of approximately 10 metres and a maximum communication range of 30 metres. The use of a short-range wireless communication link can help to ensure that the mobile device is physically present near the electronic lock, and can thus reduce the risk of spoofing attacks against the electronic lock. Thus, depending on the technology used, the short-range wireless communication link may have a communication range of: up to 200 metres; up to 100 metres; up to 50 metres; up to 30 metres; up to 10 metres; or up to 4 centimetres.

Establishing the short-range wireless communication link may be initiated by the electronic lock. For example, the electronic lock may be configured to send a first message to the mobile device, requesting establishment of the short-range wireless communication link. In response to receiving the first message, the mobile device may be configured to send a second message to the electronic lock, approving the establishment of the short-range wireless communication link. Alternatively, establishing the short-range wireless communication link may be initiated by the mobile device. For example, the mobile device may be configured to send a third message to the electronic lock, requesting establishment of the short-range wireless communication link. In response to receiving the third message, the electronic lock may be configured to send a fourth message to the mobile device, approving the establishment of the short-range wireless communication link.

The wide-area network (WAN) communication link comprises computer-networking technologies used to transmit data over long distances, and between different networks. For example, a WAN extends over a large geographic area (spanning regions, countries, or even the world) for the primary purpose of computer networking. In some implementations, a WAN is used to connect a plurality of local area networks (LANs) and/or other types of networks together, so that users and computers in one location can communicate with users and computers in other locations. The WAN communication link may comprise a cellular telephone network, a public switched telephone network (PSTN) and/or the Internet.

The locking and/or unlocking command may be transmitted, from the server to the electronic lock, using a Message Queuing Telemetry Transport (MQTT) communication protocol.

Establishing the communication session may comprise sending first authentication information to the server over the communication path. The first authentication information may be based on a first credential stored by the electronic lock.

The first credential may comprise data that is known only to the server and the electronic lock. The first authentication information may be the first credential itself. Alternatively, the first authentication information may be generated at the lock by performing one or more arithmetic and/or logic operations on the first credential. The first authentication information may be used, by the server, to verify the identity of the electronic lock. The first authentication information may thereby protect the lock against spoofing attacks, by preventing an attacker tricking the server into sending a command to an electronic lock whose identity has not been verified by the server.

Additionally or alternatively, establishing the communication session may comprise receiving second authentication information from the server over the communication path. Establishing the communication session may comprise comparing the second authentication information with a second credential stored by the electronic lock. The communication session may only be established when the second authentication information matches (e.g., is equal to) the second credential.

The second credential may comprise data that is known only to the server and the electronic lock. The second authentication information may be the second credential itself, or the second authentication information may be generated at the lock by performing one or more arithmetic and/or logic operations on the second credential. The second authentication information may be used, by the electronic lock, to verify the identity of the server. The second authentication information may thereby protect the lock against spoofing attacks, by preventing an attacker impersonating the server and sending a command to the electronic lock.

The method may further comprise the electronic lock establishing the communication path, in conjunction with the mobile device and the server. In other words, the electronic lock, the mobile device and the server may collectively perform operations to establish the communication path. The communication path is established before the communication session is established.

The communication session may be encrypted using end-to-end encryption between the server and the electronic lock.

The use of end-to-end encryption secures the electronic lock against a man-in-the-middle attack, whereby an attacker may intercept communications on the communication path (e.g., by compromising the mobile device or a router on the wide-area network communication link) and send a false command to the electronic lock. The communication session may be implemented using a secure shell (SSH) protocol or any other suitable protocol that supports end-to-end encryption.

The method of controlling an electronic lock may further comprise capturing biometric information from a user, and biometrically authenticating the user. Biometrically authenticating the user may be performed based on the captured biometric information and corresponding biometric information stored on the electronic lock.

The biometric information may be captured using a biometric sensor. The biometric sensor may comprise a fingerprint scanner and/or a camera. The camera may be configured for facial and/or iris recognition. The biometric sensor may comprise a microphone e.g. for voice recognition. The captured biometric information may comprise a fingerprint, a thumbprint, a photograph, a video recording or a voice recording.

The biometric information may be automatically obtained as a user comes within a predetermined distance of the electronic lock. Alternatively, the biometric information may only be obtained in response to a user action or request. The user action may comprise a user placing their finger or thumb on a fingerprint scanner. The user request may comprise a user manually requesting the capture of biometric information using the mobile device and/or the electronic lock.

The electronic lock may comprise a memory configured to store biometric information. The stored biometric information may comprise raw biometric data, such as a fingerprint, a thumbprint, a photograph, a video recording or a voice recording. Alternatively or additionally, the stored biometric data may comprise processed biometric data, such as a feature vector that is derived from raw biometric data. Biometrically authenticating the user may comprise comparing the captured biometric information with the biometric information stored on the electronic lock. A successful authentication of a user may involve detecting a match between the captured biometric information and the stored biometric information. The captured biometric information may be deemed to match the captured biometric information when they are identical to each other, or when they differ by less than a threshold amount.

Biometric authentication is performed by the electronic lock itself, thus avoiding the need for biometric information to be transmitted or stored elsewhere (e.g., on the mobile device or on the server). This, in turn, protects the user's biometric information.

The method may further comprise locking or unlocking the electronic lock only when the user is biometrically authenticated within a predetermined time of receiving the command.

Two-factor authentication can be achieved by locking or unlocking the electronic lock only when, within a predetermined time, both (i) the user is biometrically authenticated by the electronic lock, and (ii) the electronic lock receives a command to lock or unlock from the server. The use of two-factor authentication can improve the security of the lock by preventing the lock being compromised by a successful attack against the biometric authentication mechanism alone, or by a successful attack against the server-based authentication scheme alone. This particular two-factor authentication mechanism is especially advantageous because biometric authentication is performed by the electronic lock itself and, therefore, a successful attack against the server will not compromise the security of the biometric authentication mechanism.

The predetermined time may be set by the user. The predetermined time may be changed and/or adjusted by the user. The predetermined time may range from a few seconds to a few minutes.

Additionally or alternatively, the method may further comprise locking or unlocking the lock only when an identity of the biometrically authenticated user matches an identity of a user registered as an owner of the mobile device.

Two-factor authentication can be achieved by locking or unlocking the electronic lock only when (i) the user is biometrically authenticated by the electronic lock, and (ii) the identity of the biometrically authenticated user matches the identity of the user registered as an owner of the mobile device. The user may be registered as the owner of the mobile device using a client application installed on the mobile device. The identity of the biometrically authenticated user may be compared with the identity of the user registered as the owner of the mobile device. The comparison may be carried out by the electronic lock and/or the server. For example, the electronic lock may transmit a unique identifier of the biometrically authenticated user to the server, and the server may compare the transmitted identifier with a corresponding identifier stored on the server that uniquely identifies the registered owner of the mobile device in communication with the server. Alternatively, the electronic lock may compare the identity of the biometrically authenticated user to the identity of the user registered as an owner of the mobile device in communication with the electronic lock. The electronic lock may only be locked or unlocked if the identity of the biometrically authenticated user matches the identity of the user registered as an owner of the mobile device.

The use of two-factor authentication can improve the security of the lock by preventing the lock being compromised by a successful attack against the biometric authentication mechanism alone, or by a successful attack against the mobile device alone. This particular two-factor authentication mechanism is especially advantageous because biometric authentication is performed by the electronic lock itself and, therefore, a successful attack against the mobile device will not compromise the security of the biometric authentication mechanism.

The method may further comprise receiving a command to operate as a standalone lock. In response to receiving the command to operate as a standalone lock, the method may comprise deactivating all wireless communication hardware of the electronic lock. in particular, the method may further comprise deactivating short-range wireless communication hardware that supports the short-range wireless communication link in response to receiving the command to operate as a standalone lock.

Deactivating the short-range wireless communication hardware allows the electronic lock to be secured against cyber-attacks. When operating as a standalone lock, the electronic lock can still be locked and/or unlocked by a physical (mechanical) key and/or using biometric authentication. Deactivating the short-range wireless communication hardware may also reduce the power consumption of the electronic lock and, therefore, can increase the maintenance interval when the lock is battery-powered.

In some implementations, the electronic lock may be configured to operate as a standalone lock in response to detecting a predetermined number of failed attempts to lock and/or unlock the electronic lock within a predetermined time interval. For example, the electronic lock may be configured to count the number of failed attempts to establish a communication session with the server in a predetermined time interval. If the number of failed attempts exceeds a predetermined number, the electronic lock may be configured to automatically switch to operating as a standalone lock.

In some implementations, the electronic lock may always be capable of being locked and/or unlocked using a physical (mechanical) key. This is advantageous as it allows a user to lock and/or unlock the electronic lock even if the power supply of the electronic lock fails (e.g., due to battery discharge).

The method may further comprise receiving a reset signal and, in response to receiving the reset signal, reactivating short-range wireless communication hardware.

In some implementations, the command to operate as a standalone lock can be reversed by resetting the lock. For example, the electronic lock may comprise a hardware switch that, when activated, generates a reset signal that reactivates the short-range wireless communication hardware. Other ways of resetting the lock will occur to those skilled in the art. Alternatively, the command to operate as a standalone lock may be irreversible.

A further aspect of the disclosure provides a method of controlling an electronic lock. The method is performed at a server, and may comprise establishing a wide-area network communication link between the server and a mobile device. The method may further comprise establishing a communication session with the electronic lock, wherein the communication session enables exchanging data between the electronic lock and the server over a communication path comprising the wide-area network communication link and a short-range wireless communication link between the electronic lock and a mobile device. The method may further comprise sending a command to the electronic lock using the communication session. The command may cause the electronic lock to lock or unlock.

Establishing the communication session may comprise receiving first authentication information from the electronic lock over the communication path. Establishing the communication session may further comprise comparing the first authentication information with a first credential stored by the server. The communication session may only be established when the first authentication information matches the first credential.

Additionally or alternatively, establishing the communication session may comprise sending second authentication information to the electronic lock over the communication path, wherein the second authentication information is based on a second credential stored by the server.

The method may further comprise the server establishing the communication path, in conjunction with the mobile device and the electronic lock. In other words, the server, the mobile device and the electronic lock may collectively perform operations to establish the communication path. The communication path is established before the communication session is established.

The communication session may be encrypted using end-to-end encryption between the server and the electronic lock.

The method may optionally further comprise receiving, from the mobile device, a request to lock or unlock the electronic lock, and sending the command to the electronic lock may be performed in response to receiving the request from the mobile device.

Security of the electronic lock is improved by sending the command to lock or unlock the electronic lock only when a request is received from the same mobile device over which the short-range wireless communication link is established. In particular, the risk of a remote attacker locking or unlocking the lock is reduced by requiring the request to be received from a mobile device that is within range of the electronic lock.

Furthermore, a request received from the mobile device can be used to implement the two-factor authentication mechanism described herein. The mobile device may form the first authentication factor and biometric information may form the second authentication factor.

The mobile device may send the request to lock or unlock the electronic lock when instructed to do so by a user. For example, the mobile device may execute a computer program having a user interface through which the user can choose to lock or unlock the electronic lock. Alternatively, the mobile device may automatically send the request to lock or unlock the electronic lock. For example, the mobile device may send the request as soon as the short-range wireless communication link has been established.

In yet another implementation, sending the command to the electronic lock is performed in response to successfully establishing the communication session with the electronic lock. Specifically, the command may be sent, from the server to the electronic lock, automatically as soon as the communication session is successfully established. This implementation may allow the electronic lock to be automatically unlocked when a user comes within a predetermined distance of the electronic lock.

The method may optionally further comprise receiving, from a virtual assistant, a request to lock or unlock the electronic lock, and sending the command to the electronic lock may be performed in response to receiving the request from the virtual assistant.

The term “virtual assistant” refers to a cloud-based service that is capable of performing actions in response to voice-based commands spoken by a user. Non-limiting examples of virtual assistants include Google Assistant™, Apple Siri™ and Amazon Alexa™.

Voice control of the lock can be implemented by causing the server to send a command to lock or unlock the electronic lock in response to receiving a corresponding request from a virtual assistant. The use of a virtual assistant to provide voice control avoids the need for the electronic lock to include a microphone, which may pose privacy concerns.

A virtual assistant device may be configured to co-operate with the virtual assistant. The virtual assistant device may be configured to receive the voice-based commands spoken by a user. The virtual assistant device may be configured to transmit the received voice-based commands spoken by a user to the cloud-based virtual assistant. The virtual assistant device may include a microphone for receiving the voice-based commands. The virtual assistant device may comprise the mobile device and/or a separate client device capable of operating as a virtual assistant device. Non-limiting examples of client devices include Amazon Echo™, Amazon Echo Dot™, Google Nest Audio™ and Apple HomePod™.

The method may further comprise identifying a source of the request received from the virtual assistant, and sending the command to the electronic lock may be performed only when the source of the request is the mobile device.

The risk of a remote attacker locking or unlocking the electronic lock by compromising the virtual assistant is reduced by ensuring that the source of the request is the same mobile device over which the short-range wireless communication link is established. In this manner, the virtual assistant can be used to lock or unlock the electronic lock only when the mobile device is within range of the lock.

A further aspect of the disclosure provides an electronic lock comprising a lock mechanism, wherein the lock mechanism has a locked state and an unlocked state. The electronic lock may further comprise a controller configured to perform any of the methods disclosed herein. The controller may be further configured to lock or unlock the electronic lock by transitioning the lock mechanism to the locked stated or the unlocked state, respectively. The controller may be configured to transition the lock mechanism to the locked stated or the unlocked state in response to a receiving a command from a server.

A further aspect of the disclosure provides a server comprising one or more processors; and a memory operably coupled to the one or more processors. The memory may have stored thereon instructions that, when executed by the one or more processors, cause the server to perform any of the methods disclosed herein.

A further aspect of the disclosure provides a computer-readable medium comprising instructions that, when executed by one or more processors, cause an apparatus comprising the one or more processors to perform any of the methods disclosed herein.

### BRIEF DESCRIPTION OF THE DRAWINGS

Embodiments will now be described, purely by way of example, with reference to the accompanying drawings, in which:

FIG. 1 is a schematic diagram of a system for controlling an electronic lock;

FIG. 2 is a schematic diagram of the electronic lock shown in FIG. 1;

FIG. 3 is a schematic diagram of the server shown in FIG. 1;

FIG. 4 is a schematic diagram of the mobile device shown in FIG. 1;

FIG. 5 is a flow diagram of a method of controlling an electronic lock in accordance with the present disclosure;

FIGS. 6a and 6b are flow diagrams of methods of establishing a communication session shown in FIG. 5;

FIGS. 7a and 7b are flow diagrams of methods of biometrically authenticating a user for the purpose of two-factor authentication; and

FIG. 8 is a flow diagram of a method of configuring an electronic lock to operate as a standalone lock, in accordance with the present disclosure.

### DETAILED DESCRIPTION

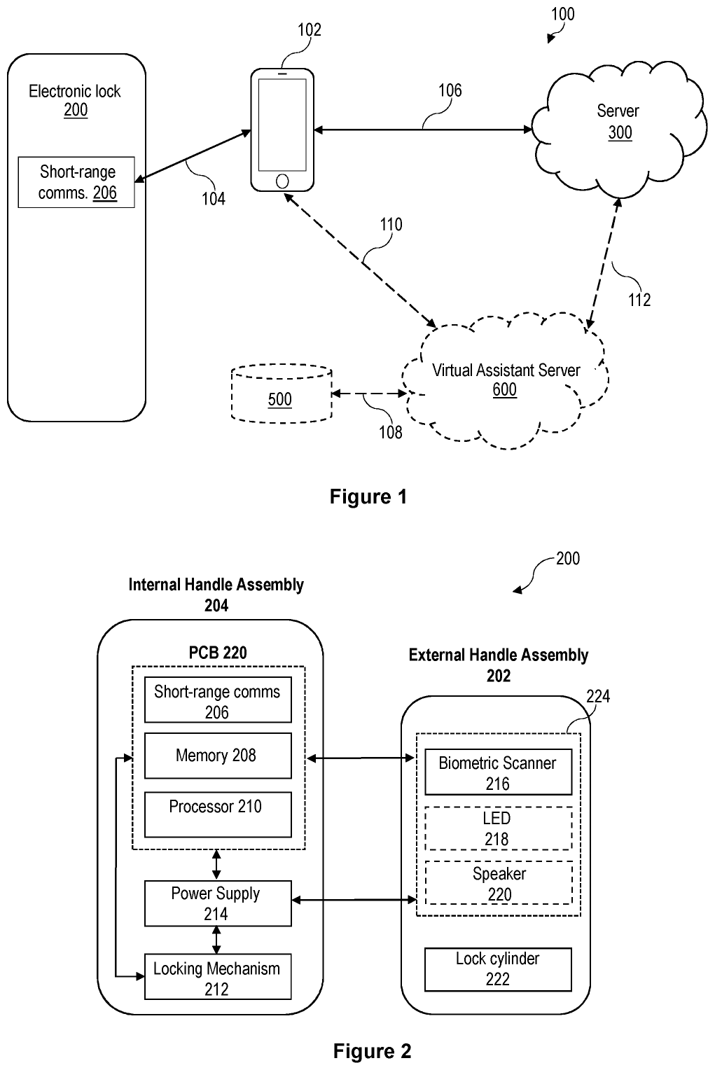

FIG. 1 is a schematic diagram of an example of a system 100 suitable for controlling an electronic lock 200 in accordance with the present disclosure. As shown in FIG. 1, the system 100 includes the electronic lock 200 itself, a mobile device 102 and a server 300. The electronic lock 200 includes short-range wireless communication hardware 206. The mobile device 102 can communicate with the electronic lock 200 using a short-range wireless communication link 104, which is supported by the short-range wireless communication hardware 206. The mobile device 102 can communicate with the server 300 using a wide-area network communication link 106. The short-range wireless communication link 104 and the wide-area network communication link 106 collectively form a communication path between the electronic lock 200 and the server 300, via the mobile device 102. In use, data can be exchanged between the electronic lock 200 and the server 300 using the communication path.

The terms “server” and “mobile device” are intended only to facilitate identification, and should not be taken to imply any limitations or requirements on the form or capabilities of those devices. Although only one server 300 is shown in FIG. 1, the disclosed functionality of the server 300 may be achieved by a plurality of servers. Such a plurality of servers may, or may not, be located at geographically distinct locations, and the disclosed functionality of the server 300 may be distributed between those servers in any suitable manner.

The short-range wireless communication link 104 may comprise a radio frequency communication link. In one implementation, the short-range wireless communication link 104 is implemented using Bluetooth™ Low Energy (BLE). BLE operates in a spectrum range of 2.400-2.4835 GHz and has a maximum communication range of 100 metres. Compared to traditional Bluetooth™ communications, BLE provides reduced power consumption while maintaining a similar communication range. Therefore, the specific selection of a BLE communication link as the short-range wireless communication link 104 is advantageous due to its relatively low power consumption. This in turn ensures that a power source of the electronic lock 200 is not drained too quickly and does not have to be replaced often.

The wide-area network communication link 106 may comprise a cellular telephone network, the Internet or a combination thereof.

Although portrayed as a mobile phone in FIG. 1 for the sake of simplicity, the mobile device 102 may be any suitable type of computing device, such as a smartphone, tablet computer, laptop computer, or a wearable device (e.g., a smartwatch). In general, the mobile device 102 is portable. A user can carry the mobile device 102 into range of the short-range wireless communication hardware 206 (e.g., approximately 10 metres for BLE) of the electronic lock 200 to form the short-range wireless communication link 104. Once a user carries the mobile device 102 outside of the range of the short-range wireless communication hardware 206 of the electronic lock 200, the short-range communication link 104 ceases to exist. Since the mobile device is portable, the short-range wireless link 104 exists only when the mobile device 102 is within range of the short-range wireless communication hardware 206 of the electronic lock 200 and, therefore, the electronic lock 200 is not permanently connected to wide-area network or the server 300. This reduces opportunities for a remote attacker to compromise the lock by connecting to it via the wide-area network.

The system 100 may optionally include a virtual assistant server 600 and a virtual assistant device 500. The virtual assistant device 500 may communicate with the virtual assistant server 600 through a first communication link 108. The virtual assistant server 600 may communicate with the server 300 through a second communication link 112. The mobile device 102 may be connected to the virtual assistant server 600 through a third communication link 110. The communication links 108, 110 and 112 may be wired or wireless communication links, or a combination thereof. The communication links 108, 110 and 112 may be implemented, at least in part, using a wide area network (WAN), such as a cellular telephone network or the Internet.

The terms “virtual assistant server” and “virtual assistant device” are intended only to facilitate identification, and should not be taken to imply any limitations or requirements on the form or capabilities of those devices. The virtual assistant device and a virtual assistant server are configured to form the virtual assistant. The term “virtual assistant” refers to a service that is capable of performing actions in response to voice-based commands spoken by a user. Non-limiting examples of virtual assistants include Google Assistant™, Apple Siri™ and Amazon Alexa™.

Although only one virtual assistant server 600 is shown in FIG. 1, the disclosed functionality of the virtual assistant server 600 may be achieved by a plurality of servers. Such a plurality of servers may, or may not, be located at geographically distinct locations, and the disclosed functionality of the virtual assistant server 600 may be distributed between those servers in any suitable manner. In some implementations, the functionality of the virtual assistant server 600 and the server 300 may be combined into a single server. For the sake of clarity, however, it will be assumed that the virtual assistant server 600 and the server 300 are distinct entities throughout the following description.

Although only one virtual assistant device 500 is shown in FIG. 1, the disclosed functionality of the virtual assistant device may be achieved by a plurality of virtual assistant devices. Alternatively, the functionality of the virtual assistant device 500 may be implemented solely by the mobile device 102. In this implementation, the mobile device 102 may be configured to act as the virtual assistant device 500. Thus, the mobile device 102 and the virtual assistant server 600 may be configured to perform the functionality of a virtual assistant.

The operation and functionality of the electronic lock 200, the mobile device 102, the server 300, the virtual assistant server 600 and the virtual assistant device 500 will be further described with reference to the following Figures.

FIG. 2 is a schematic diagram of the electronic lock 200. In the example implementation shown in FIG. 2, the electronic lock 200 comprises an internal handle assembly 204 and an external handle assembly 202. The electronic lock 200 can be fitted to any closing leaf. For example, the electronic lock 200 may be fitted to a door or a window. The internal handle assembly may be internal to the area that is to be secured by the closing leaf. The external handle assembly may external to the area that is to be secured by the closing leaf. Although portrayed as separate entities, the internal handle assembly 204 and the external handle assembly 202 could be combined into a single handle assembly comprising the elements of both the internal handle assembly 204 and the external handle assembly 202.

The internal handle assembly comprises a printed circuit board (PCB) 220, a power supply 214 and a locking mechanism 212. The short-range wireless communication hardware 206, a memory 208 and a processor 210 are all electrically and/or physically connected to the PCB 220. The external handle assembly 202 comprises an electronics module 224 and a lock cylinder 222. The electronic modules 224 comprises a biometric scanner 216. The electronics module 224 optionally further comprises a light-emitting diode (LED) 218 and/or a speaker 220. The power supply 214 is connected to, and thus supplies power to, the PCB 220, the locking mechanism 212 and the electronics module 224. The locking mechanism 212 is electrically connected to the PCB 220. The electronic modules 224 is also electrically connected to the PCB 220.

As previously mentioned, the short-range wireless communication hardware 206 supports the short-range wireless communication link 104, which allows the electronic lock 200 to exchange data with the mobile device 102.

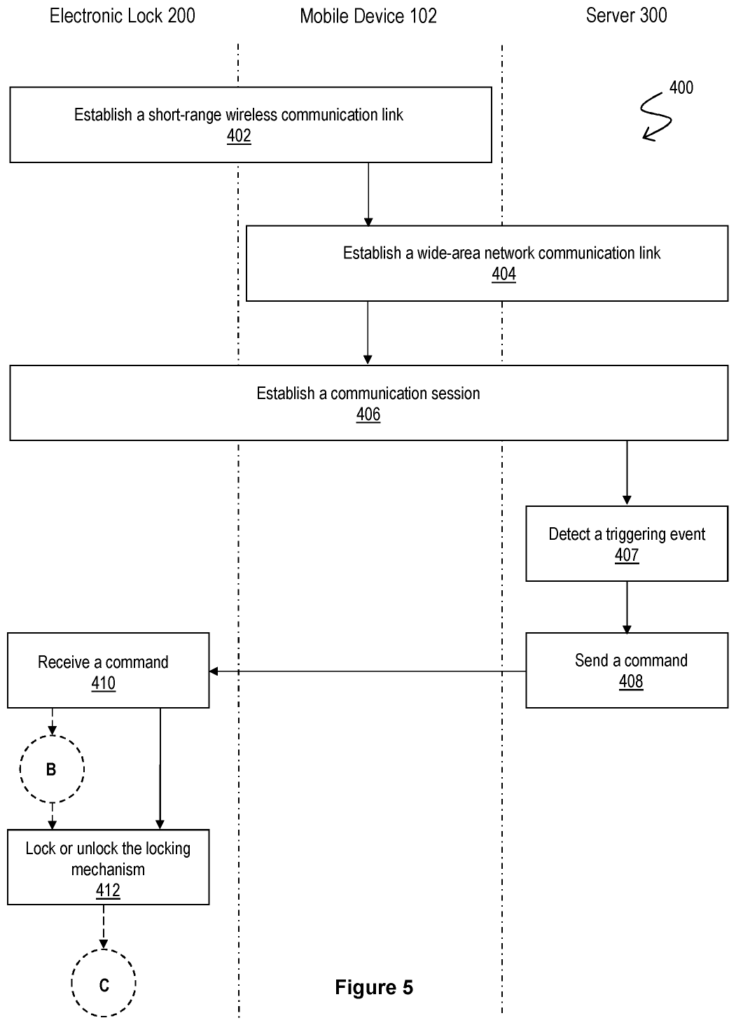

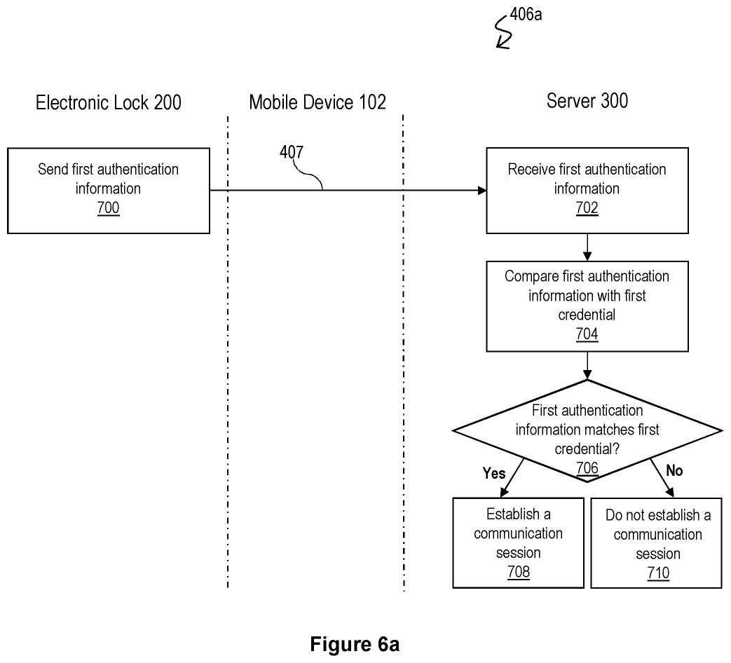

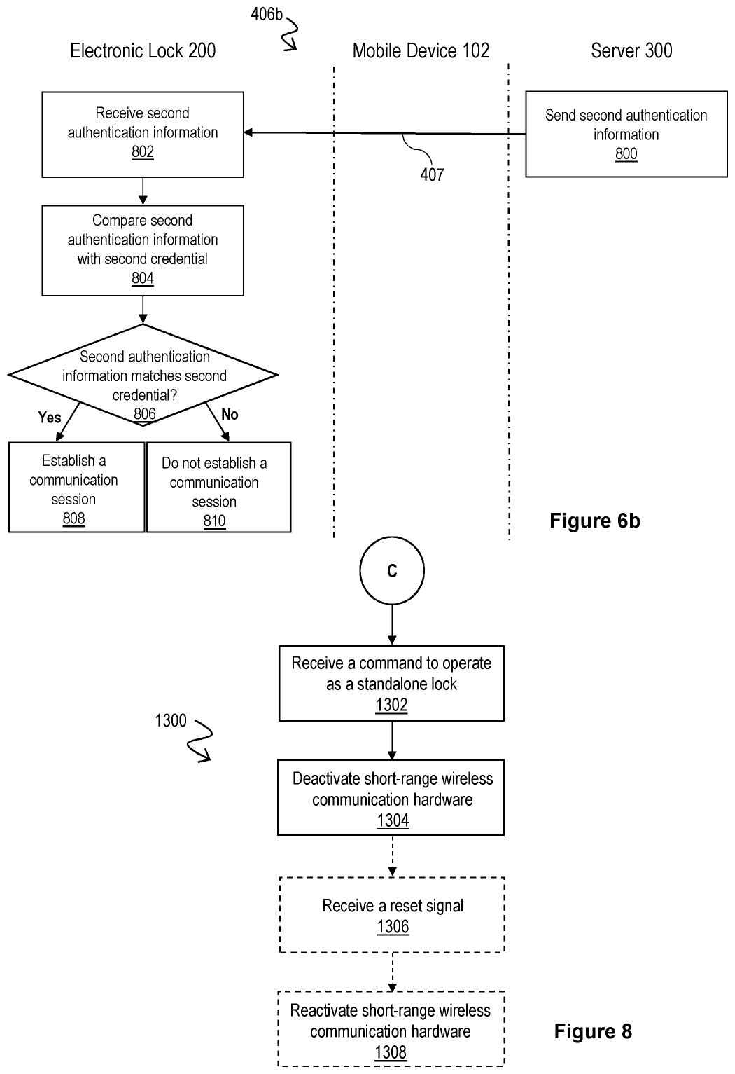

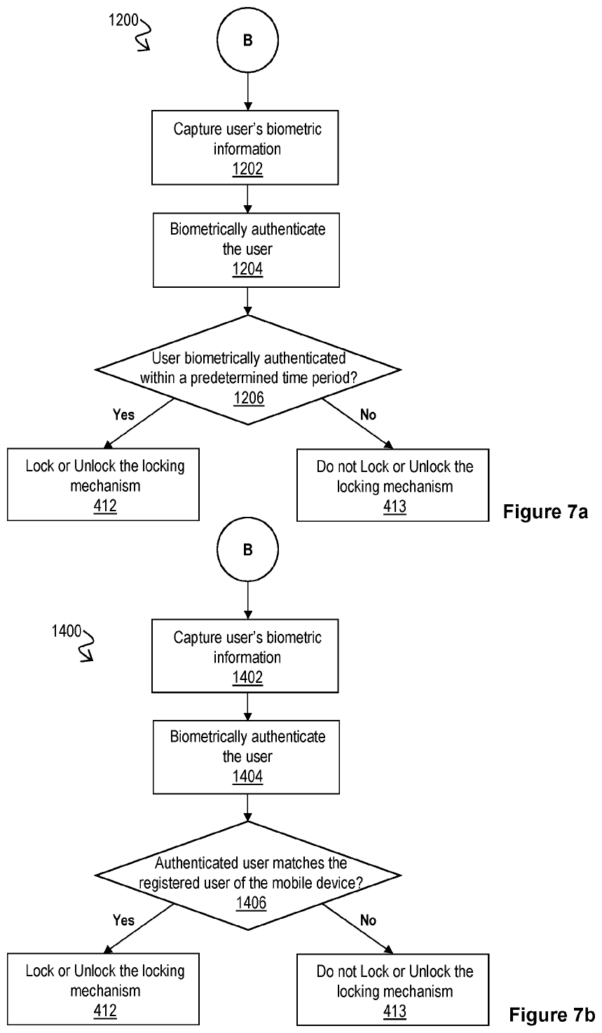

The memory 208 can include a volatile memory, a non-volatile memory, or both volatile and non-volatile memories. The memory 208 stores biometric information, a first credential and/or a second credential. The memory 208 also stores processor-executable instructions that, when executed by the processor 210, cause the electronic lock 220 to perform any of the methods described with respect to FIGS. 5, 6a, 6b, 7a, 7b and 8. In one implementation, the biometric information comprises fingerprint data of one or more users. During a process of setting up the electronic lock 200 for use, a user may input their fingerprint data into the memory 208 via the biometric scanner 216. The memory 208 is configured to store a user's fingerprint data for authenticating the user as described with reference to FIGS. 7a and 7b. The first credential and/or the second credential may be used for establishing a secure communication session between the mobile device 102 and the server 300, as described with reference to FIGS. 6a and 6b.

The memory 208 may further store an event history log (not shown). The event history log maintains a list of past events performed on the electronic lock 220. Non-limiting examples of events that may be recorded in the event history log include fingerprint setup events (i.e. when a new fingerprint data is stored in the memory 208), unlocking or locking events of the locking mechanism 212, failed attempts to lock or unlock the locking mechanism 212 and/or registration events (i.e. when a new user is registered with the electronic lock 200). The event history log may record the time and date of each event. The event history log may be accessed by a user with administrative privileges. For example, the user may be able to view the event history log directly on the electronic lock 200. Additionally or alternatively, the event history log may be transmitted by the electronic lock 200 to the mobile device 102, and the user may be able to view the event history log on the mobile device 102.

The processor 210 can be any suitable type of data processing device, such as a microprocessor, a microcontroller or application specific integrated circuit (ASIC).

The power supply 214 may comprise a linear power supply, a switch-mode power supply or a battery-based power supply. Preferably, the power supply 214 comprises commercially available batteries. The batteries may be removable, to allow the user to replace drained batteries.

The locking mechanism 212 may comprise any locking device, which can be locked or unlocked by means of an electric current. Non-limiting examples of locking mechanisms include electromagnetic locks, motor operated multi-point locks (MPLs) and/or electronic deadbolts. Other suitable electrically-operated locking mechanisms will be apparent to those skilled in the art.

Although depicted as a part of the external handle assembly 202, the biometric scanner 216 may be separate device, connected to the external handle assembly 202 and/or the internal handle assembly 204. In an example implementation, the biometric scanner 216 comprises a fingerprint scanner. The fingerprint scanner may be an optical scanner, a capacitive or CMOS scanner, an ultrasonic scanner or a thermal scanner.

A user's identity may be authenticated by using the biometric scanner 216. In an example implementation the biometric scanner 216 comprises a fingerprint scanner, the user places their finger or thumb on the fingerprint scanner. The fingerprint scanner captures fingerprint data from the user's finger or thumb, and sends it to the processor 210. The processor 210 compares the captured fingerprint data to the fingerprint data previously stored in the memory 208. If the processor 210 determines that the input fingerprint data matches the stored fingerprint data, the processor 210 successfully authenticates the user. If the processor 210 determines that the input fingerprint data does not match the stored fingerprint data, the processor 210 fails to successfully authenticate the user. Biometric authentication of a user may be utilized to determine whether to lock or unlock the locking mechanism 212, as further described with reference to FIGS. 7a and 7b.

The LED 218 and/or the speaker 220 can be used as indicators to alert a user that the locking mechanism 212 has been locked or unlocked. Additionally or alternatively, the LED 218 and/or the speaker 220 can be used to alert a user that a short-range wireless communication link 104 has been successfully established between the mobile device 102 and the electronic lock 200. Additionally or alternatively, the LED 218 and/or the speaker 220 can be used to alert a user that the communication path between the electronic lock 200 and the server 300 has been successfully established.

The lock cylinder 222 enables the locking mechanism 212 to be locked or unlocked manually, i.e. using a conventional physical key. Non-limiting examples of the lock cylinder 222 include a rim-mounted cylinder, euro-cylinder, key-in-knobset cylinder, Ingersoll-format cylinder and mortise cylinder. The lock cylinder 222 allows a user to lock or unlock the locking mechanism 212 without using any electronic components, such as the components on the PCB 220 or the biometric scanner 216. This may be useful if the power supply 214 fails, if a user loses the mobile device 102, or if a user is unable or unwilling to use the biometric scanner 216.

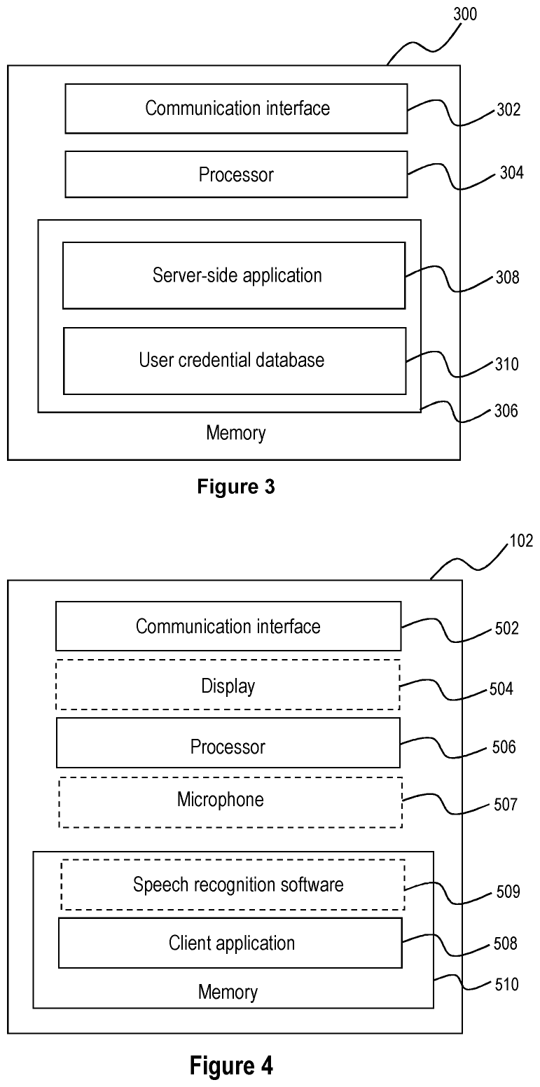

FIG. 3 is a schematic diagram of the server 300. The server 300 can be any computing device that is capable of performing the methods that are described below with reference to FIGS. 5, 6a and 6b. The server 300 comprises a processor 304, a memory 306, and a communication interface 302.

The processor 304 can be any suitable type of data processing device, such as a microprocessor, microcontroller or ASIC. The memory 306 can include a volatile memory, a non-volatile memory, or both volatile and non-volatile memories. The memory 306 stores a server-side application 308 and a user credential database 310. The server-side application 308 includes processor-executable instructions that, when executed by the processor 304, cause the server 300 to perform any of the methods disclosed in FIGS. 5, 6a and 6b. The communication interface 302 can include any suitable type of wired and/or wireless interface that enables the server 300 to communicate with the mobile device 102 via the communication link 106 and, optionally, with the virtual assistant server 600 via the communication link 106 112. Specifically, the communication interface 302 enables the server 300 to establish the wide-area network communication link 106 with the mobile device 102.

The user credential database 310 stores a first credential and/or a second credential. The first credential and/or the second credential may be used to establish a secure communication session between the mobile device 102 and the server 300, as described with reference to FIGS. 6a and 6b.

FIG. 4 is a schematic diagram of the mobile device 102. The mobile device 102 comprises a processor 506, a memory 510, a communication interface 502 and, optionally, a display 504.

The processor 506 can be any suitable type of data processing device, such as a microprocessor, microcontroller or ASIC. The memory 510 can include a volatile memory, a non-volatile memory, or both volatile and non-volatile memories. The memory 510 stores a client application 508 and, optionally, speech recognition software 509. The client application 508 includes processor-executable instructions that, when executed by the processor 506, cause the mobile device 102 to perform, or assist in performing, any of the methods described with reference to FIGS. 5, 6a and 6b.

The communication interface 502 can include any suitable types of interface that enables the mobile device 102 to communicate with the short-range wireless communication hardware 206 of the electronic lock 200 via the short-range wireless communication link 104, with the server 300 via the wide-area network communication link 106 and, optionally, with the virtual assistant server 600 via the wireless communication link 110.

The display 504 can be any suitable type of output device. For example, the display 504 may include a liquid crystal display (LCD) screen or an organic light-emitting diode (OLED) screen. The display 504 may be a touchscreen to enable data input.

The mobile device 102 may further optionally comprise a microphone 507, so that the mobile device 102 can perform the functionality of the virtual assistant device 500. Specifically, the microphone enables the mobile device 102 to detect and record voice-based commands spoken by a user. The voice-based commands may subsequently be analysed by the speech recognition software 509 stored in the memory 510 of the mobile device 102. The speech recognition software 509 coverts the voice-based commands into a command message. The command message may be subsequently sent to the virtual assistant server 600 using the communication link 110. The virtual assistant server 600 subsequently then send the command message to the server 300 using the communication link 112.

Alternatively, the speech recognition software 509 may be stored in the virtual assistant server 600 as opposed to the mobile device 102. Since analysing voice-based commands is computationally intensive, utilising the resources of the virtual assistant server 600 may reduce the processing requirements on the mobile device 102. In this implementation, the mobile device 102 records the voice based command using the microphone 507. The recording is subsequently sent to the virtual assistant server 600 for analysis. After conducting the analysis, the virtual assistant server 600 sends a voice-based command to the server 300. Controlling the electronic lock 200 using a voice-based commands will be further described with reference to FIG. 5.

### Method of Securely Controlling an Electronic Lock

FIG. 5 is a flow diagram of a method 400 of controlling the electronic lock 200 in accordance with the present disclosure. The method 400 begins at block 402, in which a short-range wireless communication link 104 is established between the electronic lock 200 and the mobile device 102.

In one implementation, establishing the short-range wireless communication link is a multi-step pairing process that may be initiated by either the mobile device 102 or the electronic lock 200. The device which initiates the process (the mobile device 102 or the electronic lock 200) is configured to broadcast a pairing request using the BLE signal. For example, the signal may comprise a BLE advertisement packet. The signal is configured to alert any devices (i.e. electronic lock 200 or mobile device 102) within range to the presence of the device which broadcasts the signal. As previously discussed, a BLE signal has a maximum communication range of approximately 100 metres. In response to detecting the beacon signal, the corresponding device may request authorisation from a user to connect to the initiating device. Upon authorisation, the mobile device 102 and the electronic lock 200 exchange pairing information such as their input/output capabilities, authentication requirements, maximum link key size and bonding requirements. The exchange of pairing information between the electronic lock 200 and the mobile device 102 is done through the pairing request and pairing response packets. The exchanged pairing information may include temporary keys that are generated by the mobile device 102 and/or the electronic lock 200. Alternatively, the temporary keys can be exchanged using other methods known to the skilled person such as the passkey exchange method. After exchanging the temporary keys, the mobile device 102 and the electronic lock 200 exchange Confirm and Rand values in order to verify that they both are using the same temporary key. Once this has been determined, the devices will use the temporary key along with the Rand values to create a short-term key. The short-term key is used to encrypt the BLE connection between the mobile device 102 and the electronic lock 200. Encrypting the BLE connection ensures that the exchanged data is secure. After the electronic lock 200 and the mobile device 102 have completed the pairing process, the electronic lock 200 and the mobile device 102 enter a connected state. In the connected state the electronic lock 200 can securely transmit or receive data from the mobile device 102 and vice versa.

If the mobile device 102 is moved outside of the communication range of the BLE signal, the short-range wireless communication link 104 is broken. Therefore, the short-range wireless communication link 104 exists only when the mobile device 102 is within range of the electronic lock 200 and, therefore, the electronic lock 200 is not permanently connected to the wide-area network. The limited range of the BLE signal ensures that a user who requests locking and/or unlocking of the locking mechanism 212 is physically present near the electronic lock 200.

In order for the devices to connect easily and quickly, the mobile device 102 can be bonded with the electronic lock 200. Bonded devices can automatically establish a connection whenever they are within BLE range, without having to exchange or generate new temporary keys. During the bonding process, long-term security keys are exchanged between the mobile device 102 and the electronic lock 200. The exchange of long-term security keys creates a permanent security relationship between the devices. The mobile device 102 and the electronic lock 200 have to be initially paired before the bonding process can occur. Thus, in subsequent interactions between the bonded electronic lock 200 and the bonded mobile device 102, the short-range wireless communication link 104 can be readily established.

The process of bonding the mobile device 102 to the electronic lock 200 may be initiated by a user. For example, the user may initiate the bonding process by using the client application 508 stored in the memory 510 of the mobile device 102. Specifically, a selectable graphic for requesting the bonding to occur may be displayed on the display 504 of the mobile device 102 by the client application 508. The user may subsequently select the graphic to initiate the bonding process. The client application 508 may require the user identity to be verified prior to executing any user requests. For example, the user may need to input credential information into the client application 508. In some implementations, the user identity may be verified using biometric recognition systems in a known manner.

At block 404, a wide-area network communication link 106 is established between the mobile device 102 and the server 300. As previously discussed, the wide-area network communication link 106 may comprise a cellular telephone network and/or the Internet. Establishing the wide-area network communication link 404 is performed in a known manner.

In combination, the short-range wireless communication link 104 and the wide-area network communication link 106 form a communication path between the electronic lock 200 and the server 300. The mobile device 102 thus acts as a conduit to allow data to be transmitted between the electronic lock 200 and the server 300.

At block 406, a secure communication session is established between the server 300 and the electronic lock 200. Methods of establishing the communication session are further described with reference to FIGS. 6a and 6b. The communication session is encrypted using end-to-end encryption between the server 300 and the electronic lock 200. Any method of encryption may be used encrypt the data transmitted between the server 300 and the electronic lock 200. For example, symmetric or asymmetric encryption methods may be utilised.

At block 407, the server 300 detects a triggering event. The triggering event causes the server 300 to send a command to the electronic lock 200. Various triggering events are further described below.

In a first implementation, the triggering event comprises a successful establishment of the communication session 406. In this implementation, the server 300 may be configured to automatically send the command to the electronic lock 200 as soon as the communication session is successfully established.

In a second implementation, the triggering event comprises receiving, by the server 300, a first message from the mobile device 102. The first message may comprise a first request to lock or unlock the electronic lock 200. The first request is transmitted using the communication session via the wide-area network communication link 106 formed between the mobile device 102 and the server 300.

The first request may be transmitted from the mobile device 102 to the server 300 automatically. For example, the mobile device may send the first request as soon as the communication session is established 406.

Alternatively, the first request may be transmitted from the mobile device 102 to the server 300 in response to a user request. For example, the client application 508 may include processor-executable instructions that, when executed by the processor 506, cause the mobile device 102 to prompt the user to instruct the mobile device 102 to send the first request. In some embodiments, the client application 508 is configured to display a selectable graphic on the display 504 that may be selected by the user to generate and send the first request to the server 300. Alternatively, the user request may comprise a voice-based command spoken by a user. In this implementation, the microphone 507 of the mobile device 102 records the voice-based command spoken by the user. The voice-based commands may subsequently be analysed by the speech recognition software 509 stored in the memory 510 of the mobile device 102. The speech recognition software 509 coverts the voice-based commands into the command message. The command message triggers the mobile device 102 to transmit the first request to the server 300 via the wide-area network communication link 106.

In a third implementation, the triggering event comprises receiving, by the server 300, a second message from the virtual assistant server 600. The second message may comprise a second request to lock or unlock the electronic lock 200.

The second request is transmitted from the virtual assistant server 600 to the server 300 via the communication link 112. Transmitting the second request is triggered by a voice-based command spoken by a user. Specifically in a first implementation, the virtual assistant device 500 is configured to record a voice-based command spoken by a user and transmit the voice-based command to the virtual assistant server 600 for analysis, via the communication link 108. The voice-based command is subsequently analysed by a speech recognition software stored in a memory of the virtual assistant server 600. The speech recognition software coverts the received voice-based command into a command message. The command message subsequently triggers the transmittal of the second request from the virtual assistant server 600 to the server 300. In a second implementation, the mobile device 102 is configured to record a voice-based command spoken by a user and transmit the voice-based command to the virtual assistant server 600 for analysis, via the communication link 110. The voice-based command is subsequently analysed by a speech recognition software stored in a memory of the virtual assistant server 600. The speech recognition software coverts the received voice-based command into a command message. The command message subsequently triggers the transmittal of the second request from the virtual assistant server 600 to the server 300.

At block 408, the server 300 sends a command to the electronic lock 200 using the previously established communication session. At block 410, the command from the server 300 is received at the electronic lock 200 using the communication session.

The command may comprise a locking or an unlocking command. In other implementations, the command is a code or an acknowledgement message signalling that the secure communication session has been successfully established.

At block 412, the electronic lock 200 locks or unlocks the locking mechanism 212. The locking or unlocking of the locking mechanism occurs in response to receiving the command at block 410. More specifically, upon receiving the command using the short-range wireless communication hardware 206, the processor 210 of the electronic lock 200 analyses and/or interprets the command. Upon successfully interpreting the command, the processor 210 sends a signal to the locking mechanism 212. The signal causes the locking mechanism to engage or disengage, thereby locking or unlocking the locking mechanism 212. In some implementations, receiving 410 the command from the server 300 does not automatically trigger locking or unlocking of the locking mechanism 212. For example, additional user authentication operations (indicated by block B in FIG. 5) may be performed before the locking mechanism is locked or unlocked. Examples of additional biometric user authentication methods are further described with reference to FIGS. 7a and 7b. In this manner a multi-factor authentication process is performed. Advantageously, the multi-factor authentication ensures that user's credentials are not easily compromised, thus improving the security with which the electronic lock 200 is controlled.

After the locking mechanism 212 has been successfully unlocked, the processor 210 may automatically send a locking signal to the locking mechanism 212 after a predetermined amount of time. The predetermined amount of time may be adjustable e.g. by a user according to the user's preference. By automatically locking the locking mechanism 212 after a predetermined amount of time, the locking mechanism is not maintained in a disengaged state indefinitely i.e. if a user forgets to lock the locking mechanism 212. In this manner, the security of the electronic lock 200 is further improved.

The electronic lock 200 may optionally receive further commands at block C of the method 400. The operations performed at block C are further described with reference to FIG. 8.

FIGS. 6a and 6b are flow diagrams of methods 406a, 406b of establishing 406 a communication session in accordance with the present disclosure.

The method 406a begins at block 700 in which the electronic lock 200 sends the first authentication information to the server 300 using the communication path 407. The communication path 407 comprises the short-range wireless communication link 104 formed between the electronic lock 200 and the mobile device 102 and the wide-area network communication link 106 formed between the mobile device 102 and the server 300. The first authentication information is received by the server 300 from the electronic lock 200 at block 702.

The first authentication information is based on the first credential stored in the memory 208 of the electronic lock 200. The first credential may comprise data that is known only to the server 300 and the electronic lock 200. In some implementations, the first authentication information may be the first credential itself. Alternatively, the first authentication information may be generated at the electronic lock 200 by performing one or more arithmetic and/or logic operations on the first credential. The first credential may be unique to the electronic lock 200. In some implementations, the first authentication information and/or the first credential may be static. Alternatively, the first authentication information and/or the first credential may be periodically updated.

At block 704, the server 300 compares the first authentication information received from the electronic lock 200 with the first credential stored in the memory 310 of the server 300. If the first authentication information has been generated at the electronic lock 200 by performing one or more arithmetic and/or logic operations on the first credential, then the server 300 may need to perform one or more arithmetic and/or logic operations on the received first authentication information to revert the first authentication information to the original first credential, prior to performing the method at the block 704.

At block 706, the server 300 determines whether the first authentication information matches the first credential stored in the memory 310 of the server 300. If the first authentication information matches the first credential, then the server 300 determines to establish the communication session at block 708 of the method 406a. If the first authentication information does not match the first credential, then the server 300 determines to not establish the communication session at block 710 of the method 406a.

The purpose of utilising the first authentication information to verify the identity of the electronic lock 200 is to protect the electronic lock 200 against spoofing attacks. The verification method prevents an attacker tricking the server 300 into sending a command to an electronic lock 200 whose identity has not been verified by the server 300.

The method 406b begins at block 800 in which the server 300 sends the second authentication information to the electronic lock 200 using the communication path 407. As noted above, the communication path 407 comprises the short-range wireless communication link 104 formed between the electronic lock 200 and the mobile device 102 and the wide-area network communication link 106 formed between the mobile device 102 and the server 300. The second authentication information is received by the electronic lock 200 from the server 300 at block 802.

The second authentication information is based on the second credential stored in the memory 310 of the server 300. The second credential may comprise data that is known only to the server 300 and the electronic lock 200. In some implementations, the second authentication information may be the second credential itself. Alternatively, the second authentication information may be generated at the server 300 by performing one or more arithmetic and/or logic operations on the second credential. The second credential may be unique to the server 300. In some implementations, the second authentication information and/or the second credential may be static. Alternatively, the second authentication information and/or the second credential may be periodically updated.

At block 804, the electronic lock 200 compares the second authentication information received from the server 300 with the second credential stored in the memory 208 of the electronic lock 200. If the second authentication information has been generated at the server 300 by performing one or more arithmetic and/or logic operations on the second credential, then the electronic lock 200 may need to perform one or more arithmetic and/or logic operations on the received second authentication information to revert the second authentication information to the original second credential, prior to performing the method at the block 804.

At block 806, the electronic lock 200 determines whether the second authentication information matches the second credential stored in the memory 208 of the electronic lock 200. If the second authentication information matches the second credential, then the electronic lock 200 determines to establish the communication session at block 808 of the method 406b. If the second authentication information does not match the second credential, then the electronic lock 200 determines not to establish the communication session at block 810 of the method 406b.

The purpose of utilising the second authentication information to verify the identity of the server 300 is to protect the electronic lock 200 against spoofing attacks. The verification method prevents an attacker tricking the electronic lock 200 into thinking that a command has been received from the server 300, without first verifying the identity of the server 300.

In some implementations both methods 406a and 406b need to be successfully performed to establish the secure communication session between the electronic lock 200 and the server 300.

FIGS. 7a and 7b are flow diagrams of methods 1200, 1400 of biometrically authenticating a user for the purpose of two-factor authentication. Methods 1200 and 1400 may be performed by the electronic lock 200 and may be carried out at block B of FIG. 5.

The method 1200 begins at block 1202, in which the electronic lock 200 captures user's biometric information. In one embodiment, the biometric information comprises a user fingerprint data and the biometric information is captured using the biometric scanner 216 of the lock 200.

At block 1204, the user is biometrically authenticated. In the one embodiment, the processor 210 compares the captured input fingerprint data to fingerprint data previously stored in the memory 208 of the electronic lock 200. If the processor 210 determines that the input fingerprint data matches the stored fingerprint data, the processor 210 successfully authenticates the user. If the processor 210 determines that the input fingerprint data does not match the stored fingerprint data, the processor 210 fails to successfully authenticate the user.

At block 1206, the electronic lock 200 determines whether the user has been biometrically authenticated within a predetermined time period of receiving the command 410 from the server 300. The predetermined time may be set by the user. The predetermined time may be changed and/or adjusted by the user according to user preference. The predetermined time may range from a few seconds to a few minutes.

If the user has been successfully biometrically authenticated within a predetermined time period of receiving the command 410 from the server 300, the electronic lock 200 locks or unlocks the locking mechanism 212 at block 412. If the user has not been successfully biometrically authenticated within a predetermined time period of receiving the command 410 from the server 300, the electronic lock 200 does not lock or unlock the locking mechanism 212 at block 413.

In this manner two-factor authentication is achieved by locking or unlocking the electronic lock 200 only when, within a predetermined time, both (i) the user is biometrically authenticated by the electronic lock, and (ii) the electronic lock 200 receives the command to lock or unlock from the server.

The method 1400 begins at block 1402, in which the electronic lock 200 captures user's biometric information. At block 1404, the electronic lock 200 the user is biometrically authenticated. The method blocks 1402 and 1404 are identical to blocks 1202 and 1204 respectively, and their decryption will not be repeated.

At block 1406, the electronic lock 200 determines whether the identity of the biometrically authenticated user matches an identity of a user registered as an owner of the mobile device 102. A particular user may be registered as the owner of the mobile device using the client application 508 stored in the memory 510 of the mobile device 102. In one implementation, during a set-up of the electronic lock 200, the user is required to register their fingerprint data and their mobile device 102 at the electronic lock 200. Matching the biometrically authenticated user to the registered user of the mobile device 102 thus involves comparing the captured fingerprint data to the previously stored mobile device identity.

If the identity of the biometrically authenticated user matches the identity of a user registered as an owner of the mobile device 102, the electronic lock 200 locks or unlocks the locking mechanism 212 at block 412. If the identity of the biometrically authenticated user does not matches the identity of a user registered as an owner of the mobile device 102, the electronic lock 200 does not lock or unlock the locking mechanism 212 at block 413.

In this manner, two-factor authentication is achieved by locking or unlocking the electronic lock 200 only when (i) the user is biometrically authenticated by the electronic lock 200, and (ii) the identity of the biometrically authenticated user matches the identity of the user registered as an owner of the mobile device.

The use of two-factor authentication can improve the security of the electronic lock 200 by preventing the electronic lock 200 from being compromised by a successful attack against the biometric scanner 216, the server 300 or the mobile device 102 in isolation.

### Operation as a Standalone Lock

FIG. 8 is a flow diagram of a method 1300 of configuring an electronic lock 200 to operate as a standalone lock, in accordance with the present disclosure. The method may be optionally performed by the electronic lock 200 at block C of FIG. 5. Alternatively, the method 1300 may be performed independently of method 400 shown in FIG. 5.

The method 1300 begins at block 1302, in which the electronic lock 200 receives a command to operate as a standalone lock. The command to operate as a standalone lock may be issued and transmitted by the mobile device 102 in response to a user request. Alternatively, the command to operate as a standalone lock may comprise an electronic signal triggered by a manual switch located on the electronic lock 200. In yet another implementation, the command to operate as a standalone lock may be generated by the electronic lock 200 itself. In this implementation, the electronic lock may be configured to count the number of failed attempts to lock and/or unlock the locking mechanism 212 using the event history log. In response to detecting a predetermined amount of failed locking and/or unlocking attempts, the electronic lock 200 may generate the command to operate as a standalone lock.

At block 1304, the electronic lock 200 deactivates the short-range wireless communication hardware. In one embodiment, the electronic lock 200 is configured to deactivate the short-range wireless communication hardware 206 in response to receiving or generating the command to operate as a standalone lock.

In the standalone state, the electronic lock 200 can still be locked and/or unlocked by a physical (mechanical) key used in conjunction with the lock cylinder 222 and/or using the biometric scanner 216 in a conventional manner.

Deactivating the short-range wireless communication hardware allows the electronic lock to be secured against cyber-attacks. Deactivating the short-range wireless communication hardware may also reduce the power consumption of the electronic lock and, therefore, can increase the maintenance interval when the lock is battery-powered. At an optional block 1306, the electronic lock 200 may receive a reset signal. The reset signal could be received from a mobile device upon a user request. Alternatively, the reset signal may comprise an electronic signal triggered by a manual switch located on the electronic lock 200. In yet another implementation, the reset signal is generated automatically after a predetermined amount of time of the electronic lock 200 remaining in the standalone state.

At an optional block 1308, the electronic lock 200 may reactivate the short-range wireless communication hardware. In one embodiment, the electronic lock 200 is configured to reactivate the short-range wireless communication hardware 206 in response to receiving or generating the reset signal.

The methods shown in FIGS. 5, 6a, 6b, and 8 can be performed by instructions stored on a processor-readable medium. The processor-readable medium may be: a read-only memory (including a PROM, EPROM or EEPROM); random access memory; a flash memory; an electrical, electromagnetic or optical signal; a magnetic, optical or magneto-optical storage medium; one or more registers of a processor; or any other type of processor-readable medium. In alternative embodiments, the present disclosure can be implemented as control logic in hardware, firmware, software or any combination thereof. The mobile device 102, the server 300, the virtual assistant server 600 and/or the virtual assistant device 500 may be implemented by dedicated hardware, such as one or more ASICs or appropriately connected discrete logic gates. A suitable hardware description language can be used to implement the method described herein with dedicated hardware.

It will be understood that the invention has been described above purely by way of example, and that modifications of detail can be made within the scope of the claims. In particular, the sequence of operations shown in FIG. 5 is merely exemplary. Any of the operations shown in the method 400 may be performed in a different order that achieves substantially the same result.

1. A method of controlling an electronic lock, the method performed at the electronic lock and comprising:
establishing a short-range wireless communication link between the electronic lock and a mobile device;
establishing a communication session with a server, wherein the communication session enables exchanging data between the electronic lock and the server over a communication path comprising the short-range wireless communication link and a wide-area network communication link between the mobile device and the server;
receiving a command from the server using the communication session; and
in response to receiving the command, locking or unlocking the electronic lock.

2. The method of claim 1, wherein establishing the communication session comprises:
sending first authentication information to the server over the communication path, wherein the first authentication information is based on a first credential stored by the electronic lock.

3. The method of claim 1, wherein establishing the communication session comprises:
receiving second authentication information from the server over the communication path;
comparing the second authentication information with a second credential stored by the electronic lock; and
establishing the communication session only when the second authentication information matches the second credential.

4. The method of claim 1, wherein the communication session is encrypted using end-to-end encryption between the server and the electronic lock.

5. The method of claim 1, further comprising:
capturing biometric information from a user; and
biometrically authenticating the user based on the captured biometric information and corresponding biometric information stored on the electronic lock.

6. The method of claim 5, further comprising:
locking or unlocking the lock only when the user is biometrically authenticated within a predetermined time of receiving the command.

7. The method of claim 5, further comprising:
locking or unlocking the lock only when an identity of the biometrically authenticated user matches an identity of a user registered as an owner of the mobile device.

8. The method of claim 1, further comprising:
receiving a command to operate as a standalone lock; and
in response to receiving the command to operate as a standalone lock, deactivating short-range wireless communication hardware that supports the short-range wireless communication link.

9. The method of claim 8, further comprising:
receiving a reset signal; and
in response to receiving the reset signal, reactivating the short-range wireless communication hardware.

10. A method of controlling an electronic lock, the method performed at a server and comprising:
establishing a wide-area network communication link between the server and a mobile device;
establishing a communication session with the electronic lock, wherein the communication session enables exchanging data between the electronic lock and the server over a communication path comprising the wide-area network communication link and a short-range wireless communication link between the electronic lock and a mobile device; and
sending a command to the electronic lock using the communication session, wherein the command causes the electronic lock to lock or unlock.

11. The method of claim 10, wherein establishing the communication session comprises:
receiving first authentication information from the electronic lock over the communication path;
comparing the first authentication information with a first credential stored by the server; and
establishing the communication session only when the first authentication information matches the first credential.

12. The method of claim 10, wherein establishing the communication session comprises:
sending second authentication information to the electronic lock over the communication path, wherein the second authentication information is based on a second credential stored by the server.

13. The method of claim 10, wherein the communication session is encrypted using end-to-end encryption between the server and the electronic lock.

14. The method of claim 10, further comprising:
receiving, from the mobile device, a request to lock or unlock the electronic lock, and wherein:
sending the command to the electronic lock is performed in response to receiving the request from the mobile device.

15. The method of claim 10, further comprising:
receiving, from a virtual assistant, a request to lock or unlock the electronic lock, and wherein:
sending the command to the electronic lock is performed in response to receiving the request from the virtual assistant.

16. The method of claim 15, further comprising:
identifying a source of the request received from the virtual assistant, and wherein:
sending the command to the electronic lock is performed only when the source of the request is the mobile device.

17. An electronic lock comprising:
a lock mechanism having a locked state and an unlocked state; and
a controller configured to: establish a short-range wireless communication link between the electronic lock and a mobile device;
establish a communication session with a server, wherein the communication session enables exchanging data between the electronic lock and the server over a communication path comprising the short-range wireless communication link and a wide-area network communication link between the mobile device and the server;
receive a command from the server using the communication session; and
in response to receiving the command, lock or unlock the electronic lock by transitioning the lock mechanism to the locked stated or the unlocked state, respectively.

18-19. (canceled)

20. The electronic lock of claim 17, wherein the controller is further configured to:
capture biometric information from a user;
biometrically authenticate the user based on the captured biometric information and corresponding biometric information stored on the electronic lock; and
lock or unlock the lock only when the user is biometrically authenticated within a predetermined time of receiving the command.

21. The electronic lock of claim 17, wherein the controller is further configured to:
receive a command to operate as a standalone lock; and
in response to receiving the command to operate as a standalone lock, deactivate short-range wireless communication hardware that supports the short-range wireless communication link.

22. The electronic lock of claim 17, wherein the controller is further configured to:
receive a reset signal; and
in response to receiving the reset signal, reactivate the short-range wireless communication hardware.
